(19) United States
(12) Patent Application Publication
(10) Pub. No.: US 2026/0085710 A1
(43) Pub. Date: Mar. 26, 2026

(54) ROD CONNECTOR DEVICE FOR THE VARIABLE, ANGLE-STABLE CONNECTION OF A FIRST ROD AND A SECOND ROD OF A LINKAGE

(71) Applicant: INSORS GMBH, Münchwald (DE)

(72) Inventor: Gregor Horacek, Ransbach-Baumbach (DE)

(21) Appl. No.: 19/336,590

(22) Filed: Sep. 23, 2025

(30) Foreign Application Priority Data
Sep. 23, 2024 (EP) 24201954.5

(51) Int. Cl. F16B 7/04; A61G 5/10; F16M 13/02

(52) U.S. Cl. CPC F16B 7/0493; A61G 5/10; F16M 13/022

(57) ABSTRACT

The invention relates to a rod connector device for the variable, angle-stable connection of a first rod and a second rod of a linkage. The invention also relates to a method for holding a terminal device on a wheelchair. The rod connector device has a first receiving unit that has a first rod mount for the first rod, and a second receiving unit that has a second rod mount for the second rod, wherein the first receiving unit and the second receiving unit are coupled to each other and can be transferred from a loose position into a clamping position, wherein, in the loose position, the receiving units can be rotated about a rotational axis with respect to each other for varying an angle of the receiving units with respect to each other, wherein the receiving units are fixed such that they cannot rotate in the clamping position.

### CROSS-REFERENCE TO RELATED APPLICATION

This application claims priority of European Patent Application No. 24201954.5 filed Sep. 23, 2024, the entire content of which is incorporated herein by reference.

### TECHNICAL FIELD

The invention relates to a rod connector device for the variable, angle-stable connection of a first rod and a second rod of a linkage. The invention also relates to a method for holding a terminal device on a wheelchair. The rods of the linkage can be solid rods or hollow rods. The first rod and/or the second rod are/is preferably formed as a hollow rod, in particular as a tube. The linkage can be, in particular, a tube linkage.

### BACKGROUND

In rehabilitation technology, there is the field of “Augmentative and Alternative Communication”. This essentially refers to the use of digital terminal devices, such as eye-controlled systems and tablet computers with software applications for speech output, which enable people with limited communication abilities (speech) to communicate with their surroundings. These terminal devices are fastened to a wheelchair, on a table, to a bed, or on a floor stand by way of special mounts. The mounts usually have a linkage with at least two rods and a rod connector device connecting the two rods. If necessary, the mount has special adapters for attaching the linkage to wheelchairs, floor stands, tables or beds.

The correct and stable orientation or adjustment of the terminal devices with respect to the person using the terminal device is essential to enable a correct interaction between the terminal device and the user and thus the correct and comfortable use of the terminal device by the user. It is necessary here to orient the rods of the linkage, which serve to secure the terminal device, for example on a wheelchair and/or a bed, with respect to each other, wherein an angle adjustment of the rods with respect to each other is necessary for this purpose. For this purpose, rod connector devices which connect a first rod and a second rod together are usually used. Such rod connector devices usually have a first receiving unit and a second receiving unit coupled to the first receiving unit, wherein the first receiving unit has a first rod mount for the first rod, and the second receiving unit has a second rod mount for the second rod. The first receiving unit and the second receiving unit are designed here in such a way that the first receiving unit and the second receiving unit can be transferred from a loose position into a clamping position, wherein the receiving units in the loose position are rotatable about a rotational axis with respect to each other for varying an angle of the receiving units with respect to each other. In the clamping position, in contrast, the receiving units should be fixed in a manner secured against rotation. Such rod connector devices are often also referred to as rod joints or as 360° joints. In the case of linkages designed as tube linkages, such joints are also referred to as tube joints. In rod connector devices known from the prior art, concentrically arranged multiple grooves are used for angle-stable fixing, wherein, in the clamping position, the peaks of the multiple grooves of the first receiving unit engage into the “troughs” of the second receiving unit and/or vice versa to thereby create an increased friction surface. In practice, however, it is shown that the known rod connector devices with multiple grooves often do not generate sufficient adhesive friction to connect the rods with each other in an angle-stable manner under load. It has been shown that the receiving units can rotate with respect to each other, in particular in an anticlockwise direction (in the case of a customary right-handed thread), and thus the set angle is adjusted under load, in particular if relatively heavy terminal devices are to be held and/or if a lever arm due to the first and/or the second rod is great.

This disadvantage is also due to the fact that a compromise is necessary between a wedging effect for angular fixation in the clamping position and the need to simply release the angular fixation again in order to allow an angle adjustment or twisting in the loose position. This is often done by a geometry design of the friction surfaces, which limits the clamping force, in order that a transfer from the clamping position into the loose position can take place with little effort.

Against this background, the challenge of a rod connector device is in particular to design the friction surfaces in such a way that their adhesive friction when clamped is great enough to keep the angle set between the receiving units and thus between the rods stable even under load, and to still ensure that that the two receiving units can be easily transferred back from the clamping position into the loose position.

It is an object of the present invention to provide a rod connector device and a method that overcome the disadvantages described above.

### SUMMARY

These objects are achieved by the subjects of the independent claims. The dependent claims relate to advantageous developments.

The rod connector device according to the invention is used for variable, angle-stable connection of a first rod and a second rod of a linkage to each other. In this respect, a connection between the first rod and the second rod can be made via the rod connector device in various angular positions, in particular in order to align a mount directly or indirectly connected to one of the rods in its orientation and position with respect to a user and then to fix it.

The rod connector device has:
a first receiving unit, wherein the first receiving unit has a first rod mount for the first rod,
a second receiving unit, wherein the second receiving unit has a second rod mount for the second rod.

The first receiving unit and the second receiving unit are coupled to each other and can be transferred from a loose position into a clamping position, wherein the receiving units are rotatable in the loose position about a rotational axis with respect to each other for varying an angle of the receiving units with respect to each other, wherein the receiving units are fixed in the clamping position in a manner secured against rotation. The first receiving unit has a first friction surface, and the second receiving unit has a second friction surface. At least one friction surface of the first friction surface and the second friction surface has one or more tongues running concentrically to the rotational axis and the other of the first friction surface and the second friction surface has one or more grooves running concentrically with respect to the rotational axis and corresponding to the one or more tongues. In the clamping position, the first receiving unit and the second receiving unit are pressed against each other along the rotational axis in such a way that the one or more tongues of the respective friction surface interact with the one or more grooves of the respective other friction surface in a non-positive manner for securing the receiving units in a manner secured against rotation. A return device acting parallel to the rotational axis is arranged between the first receiving unit and the second receiving unit, wherein the return device comprises one or more spring force elements, wherein the transfer of the first receiving unit and the second receiving unit from the loose position into the clamping position is carried out counter to the spring force of the one or more spring force elements.

By way of the above-described design of the friction surfaces in combination with the return device, a mechanically particularly stable fixation of the first receiving unit with respect to the second receiving unit in the clamping position can be achieved, wherein, due to the restoring force of the return device based on the spring force of the one or more spring force elements, a transfer of the rod connector device from the clamping position into the loose position is assisted, with the result that a transfer of the rod connector device from the clamping position into the loose position is possible without or at least with little effort, despite the high friction between the friction surfaces in the clamping position required for angular fixing.

In particular, it is provided that the first friction surface has at least one groove and the second friction surface has a tongue corresponding to the at least one groove. The first friction surface can have at least one tongue, and the second friction surface can have a groove corresponding to the at least one tongue. In particular, the first friction surface has at least one groove and at least one tongue, and the second friction surface has a tongue corresponding to the at least one groove and a groove corresponding to the at least one tongue.

The first rod and/or the second rod can be a solid rod or a hollow rod. The first rod and/or the second rod are/is preferably formed as a hollow rod, in particular as a tube. The linkage can be, in particular, a tube linkage.

The first and the second rod preferably, but not necessarily, have a round cross section.

A concentric tongue is understood to mean, in particular, a projection which runs along a circular path, and a concentric groove is understood to mean a recess which runs along a circular path.

The tongue and the groove are preferably tapered, in particular in a wedge-shaped manner, preferably conically.

In one particularly preferred embodiment, it is provided that the first receiving unit and/or the second receiving unit have/has a fixing device for fixing the rod received in the respective rod mount in a clamping manner along a longitudinal axis of the respective rod. The fixing can be carried out, for example, by a separate fixing element such as, for example, a clamping screw.

It is considered particularly advantageous if the angle between the first receiving unit and the second receiving unit is infinitely variably adjustable. In particular, it is considered advantageous in this context if the friction surfaces are free from radially running profiles or the like. Such profiles are fundamentally advantageous in terms of anti-rotation protection in the clamping position. However, such profiles prevent an infinitely variable rotation around the rotational axis and thus an infinitely variable adjustment of the angle between the receiving units. The user is restricted by such radially running profiles with regard to the angular position of the first receiving unit with respect to the second receiving unit and thus the angular position of the first rod with respect to the second rod, with the result that, if necessary, no optimum adjustment of a terminal device mounted via the linkage with respect to the user is possible.

In order to achieve a particularly high clamping force or pressing force between the first friction surface and the second friction surface in the clamping position and nevertheless to ensure a release of the friction surfaces from each other when transferring the rod connector device from the clamping position into the loose position, it is considered advantageous if the return device has a cup spring assembly with a plurality of spring force elements formed as cup springs.

In order to facilitate the transfer of the first receiving unit and the second receiving unit from the loose position into the clamping position, it is considered advantageous if the rod connector device has an actuating device for transferring the first receiving unit and the second receiving unit from the loose position into the clamping position along the rotational axis and holding the receiving units in the clamping position counter to the spring force of the one or more spring force elements, wherein the actuating device has an axle element which passes through the first receiving unit along the rotational axis.

The first receiving unit is preferably mounted rotatably on the axle element in the loose position.

In conjunction with an actuating device, it is considered advantageous if the axle element has a threaded portion, wherein the second receiving unit has a mating threaded portion, wherein the axle element is screwed with its threaded portion into the mating threaded portion, wherein an axis of the axle element coincides with the rotational axis.

For example, the axle element can be designed as a screw. It is quite conceivable here that the screw has a screw head with a tool engagement means, wherein this screw head is exposed on a side, facing away from the second receiving unit, of the first receiving unit, in order in this way to introduce a tool fitting the tool engagement means into the tool engagement means. The tool engagement means can be a hexagon socket, for example. However, other types of tool engagement means are also conceivable.

In a further embodiment, it is provided that the actuating device has an actuating lever which interacts with the axle element for transferring the first receiving unit and the second receiving unit from the loose position into the clamping position.

The actuating lever can serve, in particular, to rotate an axle element provided with a threaded portion about its axis in order to screw the axle element into the mating threaded portion of the second receiving unit for the purpose of transferring the receiving units from the loose position into the clamping position. Conversely, the axle element can be rotated in the opposite direction in order to unscrew the threaded portion of the axle element out of the mating threaded portion of the second receiving unit in order to release the receiving units, with the result that the return device can transfer the receiving units from the clamping position into the loose position.

The first receiving unit is preferably mounted on the axle element displaceably along the rotational axis. In particular, the first receiving unit has a thread-free through opening for the axle element.

It is considered particularly advantageous if the actuating lever is designed as an eccentric lever.

In such a design, it is considered to be particularly advantageous if the actuating device is designed in the manner of a quick-release lever or a quick-release device, such as are known, for example, for fixing saddle tubes or wheels in bicycles.

In one particularly preferred embodiment, it is provided that a material of the first receiving unit and the second receiving unit is a metallic material, in particular aluminium. The use of a metallic material has proven to be advantageous in order to keep the necessary forces free from damage and deformation.

In one particularly preferred embodiment, it is provided that the axle element passes through the one or more spring force elements, for example the cup springs of the cup spring assembly. By way of such a design, the assembly of the rod connector device is facilitated and, in addition, the one or more spring force elements are secured via the axle element in their radial position with respect to each other, without the need for additional position elements to be used. In this way, the axle element is advantageously given a dual function.

In one particularly preferred embodiment, it is provided that the one or more spring force elements are axially secured to the axle element. As a result, the one or more spring force elements are mounted captively on the axle element during assembly and disassembly of the rod connector device.

The axial securing of the one or more spring force elements on the axle element can be carried out, for example, by the fact that an O-ring is pushed onto the end of the axle element, which O-ring is elastically deformable and is thus held on the axle element in the axial direction in a non-positive and positively locking manner, and thus forms a stop for the one or more spring force elements in the axial direction.

It is considered to be particularly advantageous if the first receiving unit and/or the second receiving unit have/has a bearing pocket open in the direction of the respective other receiving unit for the one or more spring force elements. The bearing pocket can be formed, for example, in the form of a blind hole. The bearing pocket, in particular the blind hole, is preferably formed concentrically with respect to a through opening of the respective receiving unit, through which through opening the axle element of the actuating device passes.

It is considered to be particularly advantageous if, in the clamping position, the first receiving unit and the second receiving unit are held such that they cannot rotate by a self-locking action of the one or more tongues in the one or more grooves. For example, the self-locking action can be effected by virtue of the fact that the one or more tongues are of wedge-shaped configuration in cross section and/or the one or more grooves are of wedge-shaped configuration in cross section. In this context, it is considered to be particularly advantageous if the corresponding wedge angles are such that the flanks of the one or more tongues and the one or more grooves which bear against each other in the clamping position interact in the manner of a Morse taper.

It is considered to be particularly advantageous if the one or more tongues are formed in cross section in a wedge shape having a first wedge angle, wherein the first wedge angle is from 10° to 30°, preferably from 12° to 16°, and/or wherein the one or more grooves are formed in cross section in a wedge shape with a second wedge angle, wherein the second wedge angle is from 10° to 30°, preferably from 12° to 16°. The aforementioned ranges for the first wedge angle and the second wedge angle have proven to be particularly advantageous in order to generate a sufficient non-positive connection in the clamping position and thereby a sufficient adhesive friction in order to achieve a high rotational resistance of the first receptacle with respect to the second receptacle around the rotational axis in the clamping position.

It is considered particularly advantageous if the first wedge angle and the second wedge angle are equal in magnitude.

In one particularly preferred embodiment, it is provided that the one or more tongues are formed in cross section as a truncated cone, and/or wherein the one or more grooves are formed in cross section as a truncated cone. This design prevents damage to the one or more tongues when the rod connector device is used. In the case of acutely tapered tongues, there is a risk of the tips bending or even breaking, which can impair the function of the tongue or the plurality of tongues. In the case of acutely tapered grooves, there is a risk that foreign bodies will settle in the respective groove, which in turn may impair the function of the grooves when interacting with the tongues, namely in that the tongues can no longer be inserted sufficiently deep into the grooves due to contaminants which have settled in the grooves. This can result in insufficient adhesive friction or an insufficient non-positive connection between the respective tongue and the respective groove being brought about in the clamping position, or the tongue being damaged when the rod connector device is moved from the loose position into the clamping position due to the contamination.

In one particularly preferred embodiment, it is provided that the one or more grooves have a groove bottom, wherein, in the clamping position, the one or more tongues are spaced apart in a direction parallel to the rotational axis from the groove bottom of the one or more grooves. This ensures firstly that the one or more tongues can be inserted sufficiently deep into the grooves in the axial direction of the rotational axis, with the result that the flanks of the tongues running at an angle with respect to the rotational axis come into contact with the flanks limiting the groove in order to bring about the non-positive connection or frictionally locking connection. A distance from the tongues to the groove bottom in the axial direction of the rotational axis is also to be considered advantageous in that any contaminants in the region of the bottom do not impair a sufficient axial insertion of the tongues into the grooves.

In one particularly preferred embodiment, it is provided that the rod mount of the first receiving unit and/or that the rod mount of the second receiving unit have/has a receiving opening, delimited by a circumferential wall, for the respective rod, wherein the wall is of slotted configuration to allow narrowing of the receiving opening for the purpose of fixing the respective rod in a clamping manner in the respective receiving unit.

It is considered to be particularly advantageous if the first friction surface has at least one tongue and at least one groove and the second friction surface has, in a manner corresponding to this, at least one tongue and at least one groove.

It is considered to be particularly advantageous if the respective tongue is formed as a ring wedge tongue and the respective groove is formed as a ring wedge groove and have flanks inclined in a correspondingly wedge-shaped manner with respect to each other. The contact surfaces between the respective tongue and the respective groove are preferably formed by the flanks and, in particular, are not formed by the end surface of the respective tongue and the groove bottom of the respective groove.

It is considered to be particularly advantageous if a stroke travel between the clamping position and the loose position along the rotational axis is at least 1 mm, preferably between 1 mm and 3 mm. A height of the tongue and a height of the groove is preferably greater than the stroke travel in order to avoid an end-side contact between the tongue and the groove.

The respective rod mount is preferably arranged to receive a rod with a diameter of from 8 mm to 30 mm.

In order for a lever arm which is effective during rotation around the rotational axis between the rotational axis and the cooperating tongues and grooves to be of particularly great design, it is considered advantageous if the grooves and tongues are formed in a radially outer region of the respective friction surface.

The method according to the invention is used to hold a terminal device on a wheelchair. It is provided here that, for holding the terminal device, a linkage is fastened to the wheelchair, wherein the linkage has at least a first rod and a second rod, wherein the first rod and the second rod are connected to each other via a rod connector device according to the invention. The above comments in respect of the advantages and advantageous developments of the rod connector device apply correspondingly to the method and vice versa.

### BRIEF DESCRIPTION OF DRAWINGS

In the following figures, the invention is explained in more detail on the basis of exemplary embodiments, without being limited to these embodiments. In the figures:

FIG. 1 shows an arrangement of a first rod and a second rod, wherein the first and the second rod are connected to each other by means of a first embodiment of a rod connector device, in a perspective view,

FIG. 2 shows the rod connector device according to FIG. 1 in an exploded illustration,

FIG. 3 shows the rod connector device according to FIG. 2 in an exploded illustration in a side view,

FIG. 4 shows the rod connector device in a sectional view according to line A-A in FIG. 3,

FIG. 5 shows a partial region of FIG. 4 in an enlarged illustration,

FIG. 6 shows the rod connector device according to FIG. 2 in a sectional view in a loose position,

FIG. 7 shows the rod connector device according to FIG. 2 in a sectional view in a clamping position,

FIG. 8 shows a cup spring assembly of the rod connector device according to FIG. 2 in an exploded illustration,

FIG. 9 shows the cup spring assembly in a sectional view according to the line A-A in FIG. 8,

FIG. 10 shows an arrangement of a wheelchair and a terminal device fastened to the wheelchair via a linkage, and

FIG. 11 shows an arrangement of a first rod and a second rod, wherein the first and the second rod are connected to each other by means of a second embodiment of a rod connector device, in a perspective view.

### DETAILED DESCRIPTION

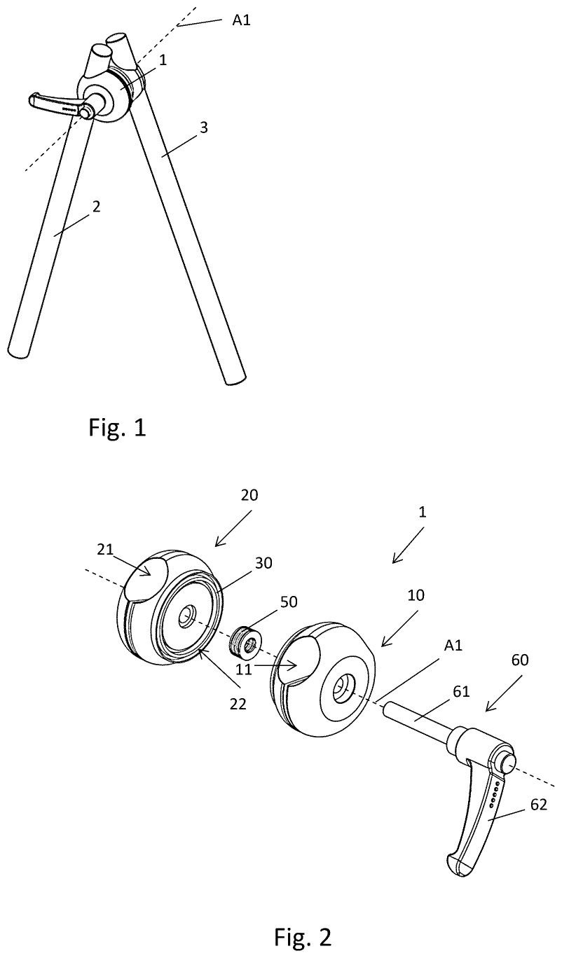

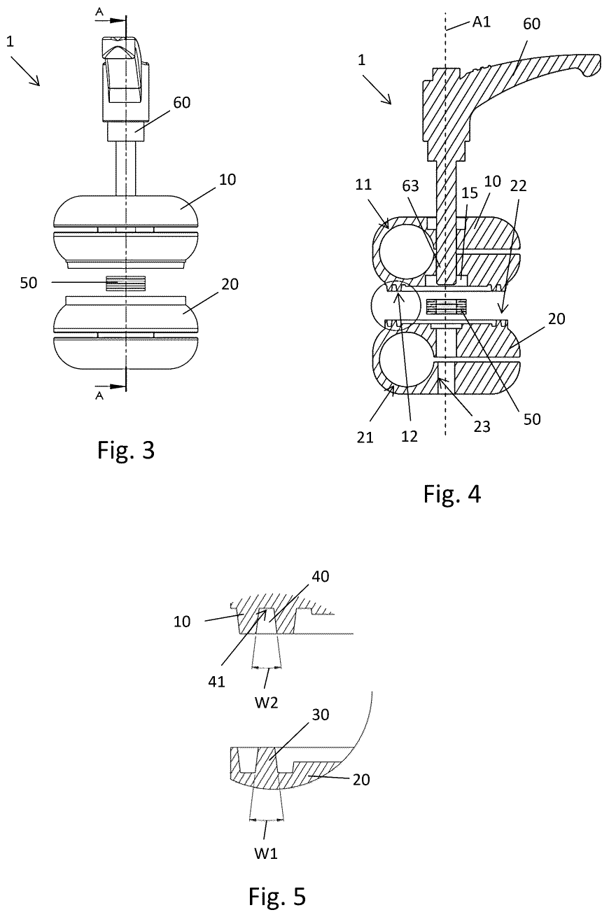

FIGS. 1 to 7 show a first embodiment of a rod connector device 1. Here, FIG. 1 shows an arrangement of a first rod 2 formed as a tube and a second rod 3 formed as a tube, wherein the first rod 2 and the second rod 3 are connected to each other via the rod connector device 1.

The rod connector device 1 serves for the variable, angle-stable connection of the first rod 2 to the second rod 3. The rod connector device 1 allows the angular position between the first rod 2 and the second rod 3 to be changed in an infinitely variable manner around the rotational axis A1 in order to set a desired angle between the first rod 2 and the second rod 3 and then to fix the set angle.

A more exemplary field of application of the arrangement as shown in FIG. 1 is shown in FIG. 10. Here, the arrangement according to FIG. 1 serves to fasten a terminal device 5 to a wheelchair 80. Here, the first rod 2 is connected to a frame 81 of the wheelchair 80 via a connecting device 82 which can be folded away. A terminal device mount 83 is attached to the second rod 3 which is connected via the rod connector device 1 to the first rod 2. The terminal device mount 83 has a bearing receptacle for the terminal device 5. The terminal device 5, which is a tablet computer in the present case, is received in the bearing receptacle and thus fixed in position with respect to the wheelchair 80.

The first embodiment of the rod connector device 1 is shown in more detail in FIGS. 2 to 7. The rod connector device 1 has a first receiving unit 10, wherein the first receiving unit 10 has a first rod mount 11 for the first rod 2. The rod connector device 1 comprises, furthermore, a second receiving unit 20, wherein the second receiving unit 20 has a second rod mount 21 for the second rod 3. The first and the second rod mount 11, 21 are each formed as circular through openings in cross section, wherein the respective receiving unit 10, 20 is of slotted configuration to allow narrowing of the through openings for the purpose of fixing the respective rod 2, 3 in a clamping manner in the rod mount 11, 21.

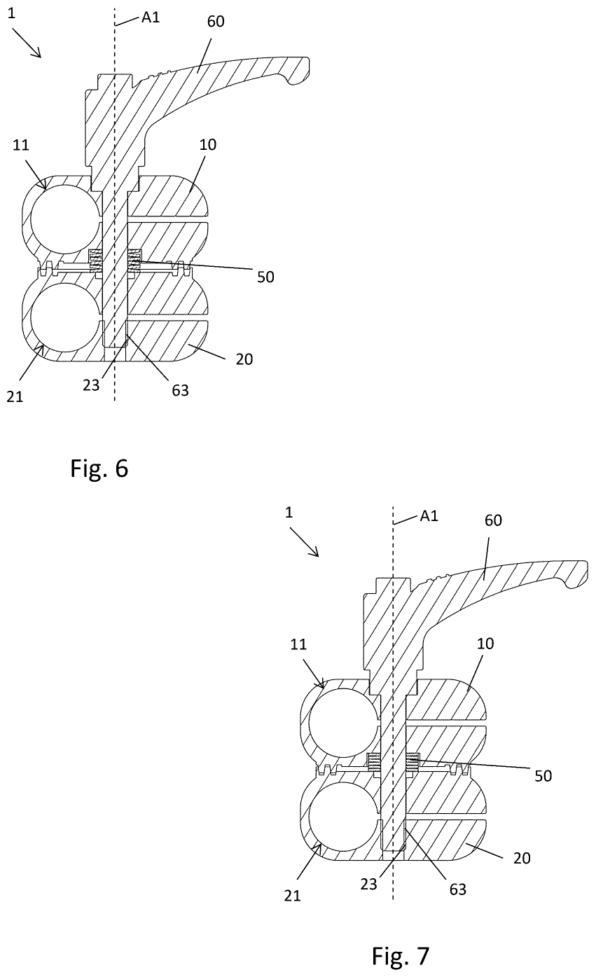

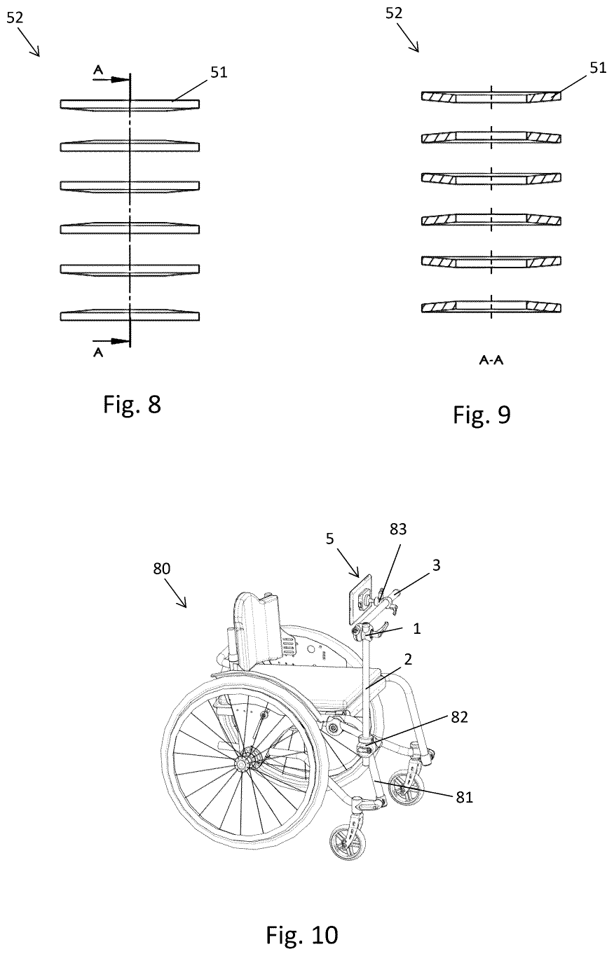

The first receiving unit 10 and the second receiving unit 20 are mechanically coupled to each other by an actuating device 60. The actuating device 60 has an axle element 61, wherein the axle element 61 passes through the first receiving unit 10, such that the receiving unit 10 is mounted on the axle element 61 rotatably about the rotational axis A1. The axle element 61 has a threaded portion 63, wherein the second receiving unit 20 has a mating threaded portion 23 corresponding to the threaded portion 63, wherein the axle element 61 is screwed with its threaded portion 63 into the mating threaded portion 23, as can be gathered, in particular, from FIGS. 6 and 7. Via the actuating device 60, the first receiving unit 10 and the second receiving unit 20 can be moved towards each other along the rotational axis A1 by screwing the axle element 61 into the mating threaded portion 23 of the second receiving unit 20, are thereby compressed and in this way are transferred from a loose position into a clamping position, as described in more detail below.

FIG. 7 shows the receiving units 10, 20 in their clamping position. FIG. 6 shows the receiving units 10, 20 in their loose position. The clamping position differs from the loose position in that, in the clamping position, the axle element 61 is further screwed into the second receiving unit 20, whereby the first receiving unit 10 and the second receiving unit 20 are pressed together along the rotational axis A1. In the loose position, in contrast, the axle element 61 is screwed less far into the second receiving unit 20, with the result that the first receiving unit 10 and the second receiving unit 20 are not pressed together along the rotational axis A1. In order to facilitate the screwing and unscrewing of the axle element 61 into/from the second receiving unit 20, the actuating device 60 has an actuating lever 62. Such a configuration of the actuating device in conjunction with the rod connector device is also frequently referred to by the term “clamping lever”.

In the clamping position, a first friction surface 12 of the first receiving unit 10 and a second friction surface 22 of the second receiving unit 20 are in contact with each other in such a way that the receiving units 10, 20 are fixed in the clamping position to each other such that they cannot rotate. Accordingly, in the clamping position, the first receiving unit 10 and the second receiving unit 20 are fixed in an angle-stable manner with respect to each other by non-positive interaction of the first friction surface 12 and the second friction surface 22. In the loose position, in contrast, the first friction surface 12 and the second friction surface 22 are spaced apart from each other in the axial direction of the rotational axis A1, whereby a rotation of the receiving units 10, 20 with respect to each other about the rotational axis A1 is enabled in the loose position in order to vary an angle between the receiving units 10, 20.

In order to achieve a particularly high adhesive friction in the clamping position between the first friction surface 12 and the second friction surface 22, the first friction surface 12 has a groove 40 extending concentrically with respect to the rotational axis A1. The second friction surface 22 has a tongue 30 corresponding to the groove 40 and extending concentrically with respect to the rotational axis A1.

In the clamping position shown in FIG. 7, the first receiving unit 10 and the second receiving unit 20 are pressed against each other by the actuating device 60 along the rotational axis A1 in such a way that the tongue 30 of the second friction surface 22 is moved into the groove 40 of the first friction surface 12 in such a way that flanks of the tongue 30 bear flatly against the flanks of the groove 40, whereby a non-positive connection is effected between the tongue 30 and the groove 40 for the fixing of the receiving units 10, 20 such that they cannot rotate in the angular position present when transferring into the clamping position.

In order to ensure that, when the actuating device 60 is screwed out of the second receiving unit 20, the mutually engaged friction surfaces 12, 22 are also again released from each other, a return device 50 acting parallel to the rotational axis A1 is arranged between the first receiving unit 10 and the second receiving unit 20. In the present case, the return device 50 comprises six spring force elements 51 which are designed as cup springs, wherein the cup springs form a cup spring assembly 52. The cup spring assembly 52 is stored in a bearing pocket 15 formed in the first receiving unit 10, wherein the bearing pocket 15 is open in the direction of the second receiving unit 20. The axle element 61 passes through the cup springs of the cup spring assembly 52, and the cup spring assembly 52 is supported with its one end on the first receiving unit 10 in the axial direction of the rotational axis A1 and with its other end on the second receiving unit 20 in the axial direction of the rotational axis A1. The cup springs of the cup spring assembly 52 are compressed in the clamping position counter to the spring force of the cup spring assembly 52. Accordingly, the first receiving unit 10 and the second receiving unit 20 are transferred from the loose position into the clamping position counter to the spring force of the cup spring assembly 52. This is achieved by virtue of the fact that, when the actuating device 60 is screwed out, the first receiving unit 10 and the second receiving unit 20 are pressed apart by the cup spring assembly 52 along the rotational axis A1 in order to move the groove 40 and the tongue 30 out of engagement and thereby to transfer the receiving units 10, 20 back into the loose position or to assist at least a transfer into the loose position.

As can be seen in particular from FIG. 5, the tongue 30 is of wedge-shaped configuration in cross section with a first wedge angle W1, wherein this first wedge angle W1 is 14° in the present case. The groove 40 is likewise of wedge-shaped configuration in cross section with a second wedge angle W2, wherein this second wedge angle W2 is of identical magnitude to the first wedge angle W1 and is accordingly likewise 14°.

As can be seen in particular from FIG. 7, the groove 40 and the tongue 30 are designed such that, in the clamping position, the tongue 30 is spaced apart from a groove bottom 41 of the groove 40 in the axial direction of the rotational axis A1.

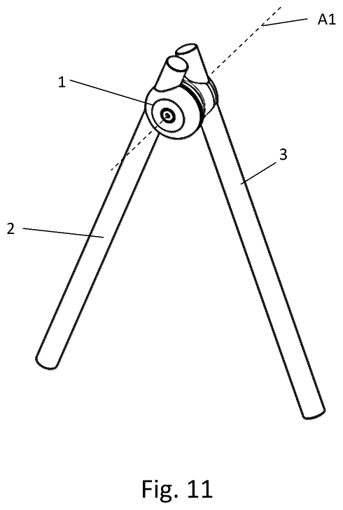

FIG. 11 shows, in an analogous manner with respect to FIG. 1, an arrangement of a first rod 2 and a second rod 3, wherein the rods 2, 3 are connected to each other via a second embodiment of the rod connector device 1. The second embodiment of the rod connector device 1 differs from the first embodiment of the rod connector device 1 according to FIGS. 1 to 7 essentially by way of the design of the actuating device 60. In the second embodiment shown in FIG. 11, the actuating device 60 once again has an axle element 61, wherein this axle element 61 is formed as a screw with a screw head in the present case. Accordingly, the actuating device 60 does not have an actuating lever 62. In order to turn the screw, the screw head has a tool engagement means which is accessible from a side of the first receiving unit 10 facing away from the second receiving unit 20. The tool engagement means is designed as a hexagon socket in the present case.

### LIST OF REFERENCE SIGNS

1 Rod connector device
2 First rod
3 Second rod
5 Terminal device
10 First receiving unit
11 First rod mount
12 First friction surface
20 Second receiving unit
21 Second rod mount
22 Second friction surface
23 Mating threaded portion
30 Tongue
40 Groove
41 Groove bottom
50 Return device
51 Spring force elements
52 Cup spring assembly
60 Actuating device
61 Axle element
62 Actuating lever
63 Threaded portion
80 Wheelchair
81 Frame
82 Connecting device
83 Terminal device mount
A1 Rotational axis
W1 First wedge angle
W2 Second wedge angle

1. Rod connector device for the variable, angle-stable connection of a first rod and a second rod of a linkage to each other, wherein the rod connector device comprises:
a first receiving unit, wherein the first receiving unit has a first rod mount for the first rod,
a second receiving unit, wherein the second receiving unit has a second rod mount for the second rod,
wherein the first receiving unit and the second receiving unit are coupled to each other and can be transferred from a loose position into a clamping position, wherein the receiving units can be rotated in the loose position about a rotational axis with respect to each other for varying an angle of the receiving units with respect to each other, wherein the receiving units are fixed in the clamping position such that they cannot rotate, wherein the first receiving unit has a first friction surface and the second receiving unit has a second friction surface, wherein at least one of the first friction surface and the second friction surface has one or more tongues extending concentrically with respect to the rotational axis, and the other of the first friction surface and the second friction surface has one or more grooves running concentrically with respect to the rotational axis and corresponding to the one or more tongues, wherein, in the clamping position, the first receiving unit and the second receiving unit are pressed against each other along the rotational axis, in such a way that the one or more tongues of the respective friction surface interact in a non-positive manner with the one or more grooves of the respective other friction surface for fixing the receiving units such that they cannot rotate, wherein a return device acting parallel to the rotational axis is arranged between the first receiving unit and the second receiving unit, wherein the return device comprises one or more spring force elements, wherein the transfer of the first receiving unit and the second receiving unit from the loose position into the clamping position takes place counter to the spring force of the one or more spring force elements.

2. Rod connector device according to claim 1, wherein the return device has a cup spring assembly with a plurality of spring force elements formed as cup springs.

3. Rod connector device according to claim 1, wherein the rod connector device has an actuating device for transferring the first receiving unit and the second receiving unit from the loose position into the clamping position along the rotational axis and for holding the receiving units in the clamping position counter to the spring force of the one or more spring force elements, wherein the actuating device has an axle element which passes through the first receiving unit along the rotational axis, and the first receiving unit is preferably mounted rotatably on the axle element in the loose position.

4. Rod connector device according to claim 3, wherein the axle element has a threaded portion, wherein the second receiving unit has a mating threaded portion, wherein the axle element is screwed with its threaded portion into the mating threaded portion, wherein an axis of the axle element coincides with the rotational axis.

5. Rod connector device according to claim 4, wherein the axle element is formed as a screw.

6. Rod connector device according to claim 3, wherein the actuating device has an actuating lever which interacts with the axle element for transferring the first receiving unit and the second receiving unit from the loose position into the clamping position.

7. Rod connector device according to claim 3, wherein the axle element passes through the one or more spring force elements.

8. Rod connector device according to claim 7, wherein the one or more spring force elements are axially secured on the axle element.

9. Rod connector device according to claim 1, wherein the first receiving unit and/or the second receiving unit have/has a bearing pocket open in the direction of the respective other receiving unit for the one or more spring force elements.

10. Rod connector device according to claim 1, wherein, in the clamping position, the first receiving unit and the second receiving unit are held such that they cannot rotate by a self-locking action of the one or more tongues in the one or more grooves.

11. Rod connector device according to claim 1, wherein the one or more tongues are formed in cross section as a wedge with a first wedge angle, wherein the first wedge angle is from 10° to 30°, and/or wherein the one or more grooves are formed in cross section as a wedge with a second wedge angle, wherein the second wedge angle is from 10° to 30°.

12. Rod connector device according to claim 1, wherein the one or more tongues are formed in cross section as a truncated cone, and/or wherein the one or more grooves are formed in cross section as a truncated cone.

13. Rod connector device according to claim 1, wherein the one or more grooves have a groove bottom, wherein, in the clamping position, the one or more tongues are spaced apart from the groove bottom of the one or more grooves in a direction parallel to the rotational axis.

14. Rod connector device according to claim 1, wherein the rod mount of the first receiving unit and/or wherein the rod mount of the second receiving unit have/has a receiving opening, delimited by a peripheral wall, for the respective rod, wherein the wall is of slotted formation in order to allow narrowing of the receiving opening for the purpose of fixing the respective rod in a clamping manner in the respective receiving unit.

15. Method for holding a terminal device on a wheelchair, wherein, in order to hold the terminal device, a linkage is attached to the wheelchair, wherein the linkage has at least one first rod and a second rod, wherein the first rod and the second rod are connected to each other via a rod connector device according to claim 1.
